(19) United States
(12) Patent Application Publication
(10) Pub. No.: US 2025/0184652 A1
(43) Pub. Date: Jun. 5, 2025

(54) APPARATUS AND METHOD FOR CONTROLLING AUDIO SIGNAL ON BASIS OF SENSOR

(71) Applicant: SAMSUNG ELECTRONICS CO., LTD., Suwon-si (KR)

(72) Inventors: Jeock LEE, Suwon-si (KR); Chulmin Choi, Suwon-si (KR); Jonghwan Kim, Suwon-si (KR); Jinyong Kim, Suwon-si (KR); Talyong Kim, Suwon-si (KR); Wonju Seo, Suwon-si (KR); Yonghoon Lee, Suwon-si (KR)

(73) Assignee: SAMSUNG ELECTRONICS CO., LTD., Suwon-si (KR)

(21) Appl. No.: 19/046,183

(22) Filed: Feb. 5, 2025

Related U.S. Application Data
(63) Continuation of application No. PCT/KR2023/010999, filed on Jul. 27, 2023.

(30) Foreign Application Priority Data
Aug. 5, 2022 (KR) 10-2022-0098009
Aug. 9, 2022 (KR) 10-2022-0099584

(51) Int. Cl. H04R 1/10; H04R 3/04

(52) U.S. Cl. CPC H04R 1/1083; H04R 1/1041; H04R 3/04; H04R 1/1016; H04R 2400/01; H04R 2410/05

(57) ABSTRACT

A method performed by an audio device, includes: outputting a first audio signal through at least one speaker, receiving a noise signal through at least one microphone, generating a tuning signal based on the noise signal, outputting, through the at least one speaker, a second audio signal that combines the generated tuning signal and the first audio signal, detecting an external input through at least one sensor, changing a gain of filter circuitry based on the external input; generating an output signal by passing, through the filter circuitry, the second audio signal received through the at least one microphone; and outputting the output signal through the at least one speaker.

### CROSS-REFERENCE TO RELATED APPLICATIONS

This application is a by-pass continuation application of International Application No. PCT/KR2023/010999, filed on Jul. 27, 2023, which is based on and claims priority to Korean Patent Application Nos. 10-2022-0098009, filed on Aug. 5, 2022, and 10-2022-0099584, filed on Aug. 9, 2022, in the Korean Intellectual Property Office, the disclosures of which are incorporated by reference herein their entireties.

### BACKGROUND

### 1. Field

The disclosure relates to a device and a method for controlling an audio signal based on a sensor.

### 2. Description of Related Art

In order to output a sound signal, an audio device (e.g., earbuds) may be used. In order to remove ambient noise while outputting the sound signal, the audio device may perform a noise canceling (e.g., active noise cancellation (ANC)) function through a microphone and a speaker. In addition, in order to obtain ambient sound more accurately, the audio device may perform an ambient sound allowance function for hearing ambient sound or a ‘personal sound amplification products’ (PSAP) function, by using a microphone.

The above-described information may be provided as related art for the purpose of helping to understand the present disclosure. No claim or determination is raised as to whether any of the above-described information may be applied as prior art related to the present disclosure.

### SUMMARY

According to an aspect of the disclosure, an audio device includes: at least one speaker; at least one microphone; filter circuitry comprising a plurality of partial filter circuits; at least one sensor; and at least one processor operatively connected to the at least one speaker, the at least one microphone, the filter circuitry, and the at least one sensor; wherein the at least one processor is configured to: output a first audio signal through the at least one speaker, receive a noise signal through the at least one microphone, generate a tuning signal based on the noise signal, output, through the at least one speaker, a second audio signal that combines the generated tuning signal and the first audio signal, detect an external input through the at least one sensor, change a gain of the filter circuitry based on the external input, generate an output signal by passing, through the filter circuitry, the second audio signal received through the at least one microphone, and output the output signal through the at least one speaker.

The at least one processor may be further configured to activate at least one partial filter circuit of the plurality of partial filter circuits and deactivate at least another partial filter circuit of the plurality of partial filter circuits.

The at least one processor may be further configured to change a weight of each of the plurality of partial filter circuits.

The audio device may further include: a housing coupled to the at least one sensor; and a protrusion part coupled with the housing, wherein the at least one microphone includes a feedback microphone on a surface of the housing.

The audio device may further include: a housing coupled to the at least one sensor; and a protrusion part coupled with the housing, wherein the at least one microphone may include a reference microphone on a surface of the housing.

The at least one sensor may include a touch detection sensor, and wherein the external input detected by the touch detection sensor may include a touch input.

The at least one processor may be further configured to: obtain first phase information of the noise signal; and obtain second phase information for cancelling the first phase information, and wherein the tuning signal may be generated based on the second phase information.

The at least one processor may be further configured to reduce a gain for frequencies within a designated range for howling cancelation based on a pressure of the external input.

According to an aspect of the disclosure, a method performed by an audio device, includes: outputting a first audio signal through at least one speaker, receiving a noise signal through at least one microphone, generating a tuning signal based on the noise signal, outputting, through the at least one speaker, a second audio signal that combines the generated tuning signal and the first audio signal, detecting an external input through at least one sensor, changing a gain of filter circuitry based on the external input; generating an output signal by passing, through the filter circuitry, the second audio signal received through the at least one microphone; and outputting the output signal through the at least one speaker.

According to an aspect of the disclosure, a method performed by an audio device, includes: outputting a first audio signal through at least one speaker, receiving a noise signal through at least one microphone, generating a tuning signal based on the noise signal, outputting, through the at least one speaker, a second audio signal that combines the generated tuning signal and the first audio signal, detecting an external input through at least one sensor, changing a gain of filter circuitry based on the external input; generating an output signal by passing, through the filter circuitry, the second audio signal received through the at least one microphone; and outputting the output signal through the at least one speaker.

The changing the gain of the filter circuitry, may include: activating at least one partial filter circuit of a plurality of partial filter circuits of the filter circuitry; and deactivating at least another partial filter circuit of the plurality of partial filter circuits of the filter circuitry.

The changing the gain of the filter circuitry, may include changing a weight of each of a plurality of partial filter circuits of the filter circuitry.

The at least one microphone may include a feedback microphone on a surface of a housing to which a sensor is coupled.

The at least one microphone may include a reference microphone on a surface of a housing to which a protrusion part is coupled.

According to an aspect of the disclosure, a non-transitory computer-readable medium, when executed by one or more processors, provisioned with program instructions that perform functions including: outputting a first audio signal through at least one speaker, receiving a noise signal through at least one microphone, generating a tuning signal based on the noise signal, outputting, through the at least one speaker, a second audio signal that combines the generated tuning signal and the first audio signal, detecting an external input through at least one sensor, changing a gain of filter circuitry based on the external input; generating an output signal by passing, through the filter circuitry, the second audio signal received through the at least one microphone; and outputting the output signal through the at least one speaker.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an example of a state in which an audio device is close to a user's body, according to an embodiment;

FIG. 2 illustrates an example of a state in which an audio device is connected to a power supply device, according to an embodiment;

FIG. 3 illustrates components of an audio device, according to an embodiment;

FIG. 4 illustrates an example of wearing an audio device, according to an embodiment;

FIG. 5 illustrates an example of movement of an audio device according to an embodiment;

FIG. 6A illustrates an example of a signal inflow characteristic through a secondary path according to a clogging amount of a speaker port;

FIG. 6B illustrates an example of a signal inflow characteristic according to a volume of external auditory canal;

FIG. 7 illustrates a functional configuration of an audio device, according to an embodiment;

FIG. 8A illustrates an example of a functional configuration of an audio device including a filter circuitry combination unit according to an embodiment;

FIG. 8B illustrates an example of a functional configuration of an audio device including partial filter circuits according to an embodiment;

FIG. 8C illustrates an example of a functional configuration of an audio device including a filter circuitry combination unit according to an embodiment;

FIG. 9 illustrates an example of a functional configuration of an audio device for controlling a filter characteristic without a microphone, according to an embodiment;

FIG. 10 illustrates an operation of an audio device for controlling an audio signal while an active noise cancellation (ANC) is performed, according to an embodiment; and

FIG. 11 illustrates an operation of an audio device for controlling an audio signal while an ambient sound allowance function for hearing ambient sound or a PSAP function is performed, according to an embodiment.

### DETAILED DESCRIPTION

Terms used in the present disclosure are used only to describe a specific embodiment, and may not be intended to limit a range of another embodiment. A singular expression may include a plural expression unless the context clearly means otherwise. Terms used herein, including a technical or a scientific term, may have the same meaning as those generally understood by a person with ordinary skill in the art described in the present disclosure. Among the terms used in the present disclosure, terms defined in a general dictionary may be interpreted as identical or similar meaning to the contextual meaning of the relevant technology and are not interpreted as ideal or excessively formal meaning unless explicitly defined in the present disclosure. In some cases, even terms defined in the present disclosure may not be interpreted to exclude embodiments of the present disclosure.

In one or more embodiments of the present disclosure described below, a hardware approach will be described as an example. However, since the one or more embodiments of the present disclosure include technology that uses both hardware and software, the one or more embodiments of the present disclosure do not exclude a software-based approach.

Terms referring to a feedback microphone (e.g., feedback microphone, error microphone, the first microphone), terms referring to a reference microphone (e.g., a reference microphone, a feedforward microphone, a second microphone), and terms referring to audio equipment (e.g., audio device, audio output equipment, true wireless stereo earphone) used in the following description are exemplified for convenience of explanation. Therefore, the present disclosure is not limited to terms to be described below, and another term having an equivalent technical meaning may be used. In addition, a term such as ‘ . . . unit,’ . . . device', ‘ . . . material’, and ‘ . . . structure’, and the like used below may mean at least one shape structure or may mean a unit processing a function.

In addition, in the present disclosure, the term ‘greater than’ or ‘less than’ may be used to determine whether a particular condition is satisfied or fulfilled, but this is only a description to express an example and does not exclude description of ‘greater than or equal to’ or ‘less than or equal to’. A condition described as ‘greater than or equal to’ may be replaced with ‘greater than’, a condition described as ‘less than or equal to’ may be replaced with ‘less than’, and a condition described as ‘greater than or equal to and less than’ may be replaced with ‘greater than and less than or equal to’. In addition, hereinafter, ‘A to B’ refers to at least one of elements from A (including A) to B (including B). Hereinafter, ‘C’ and/or ‘D’ refer to including at least one of ‘C’ or ‘D’, that is, {‘C’, ‘D’, and ‘C’ and ‘D’}.

Before describing embodiments of the present disclosure, terms necessary to describe operations of an audio device according to the embodiments are defined. The audio device may mean an electronic device including a speaker for outputting an audio signal. The audio signal may mean sound waves outputted from the audio device. A first microphone, which is a feedback microphone, may mean a microphone disposed on a surface including a ‘protrusion unit’ of a housing. Throughout the disclosure, a protrusion part is interchangeable with the protrusion unit. A second microphone, which is a feed forward microphone, may mean a microphone disposed on a surface including a sensor of the housing. A signal inflow characteristic may mean a measure of how much an audio signal of a speaker flows into the microphone.

Hereinafter, one or more embodiments disclosed in the present document will be described with reference to the accompanying drawings. For convenience of description, components illustrated in the drawings may be exaggerated or minimized, and the present invention is not necessarily limited thereto.

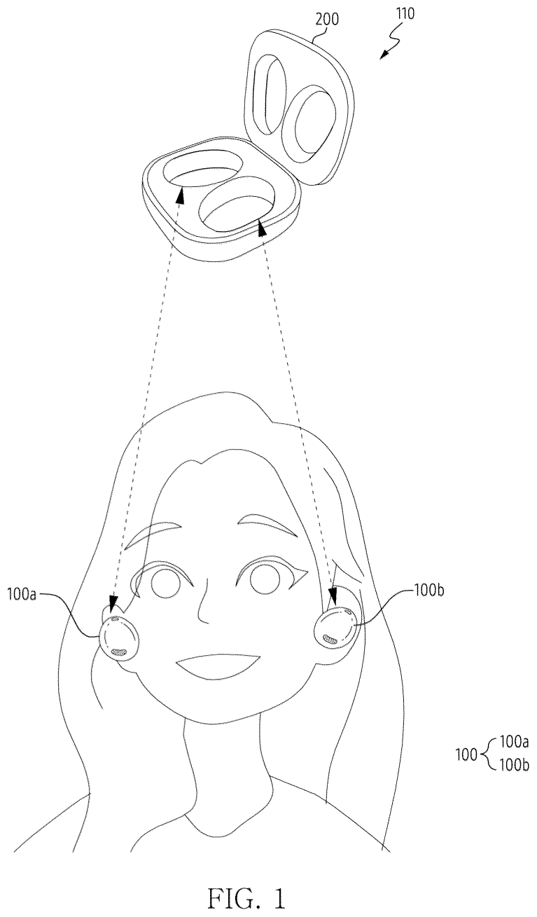

FIG. 1 illustrates an example of a state in which an audio device is close to a user's body, according to an embodiment.

In FIG. 1, in a case that an audio device 100 is not used, the audio device 100 may be accommodated and stored in a power supply device 200. In a case that the audio device 100 is used, the audio device 100 may be worn on and close to a part of a body (e.g., an ear) of a user. According to an embodiment, the audio device 100 may be configured as a pair to be worn on and close to the user's two ears. For example, the audio device 100 may include a right audio device 100a capable of being worn on and close to the user's right ear and a left audio device 100b capable of being worn on and close to the user's left ear. According to an embodiment, the audio device 100 may output an audio signal in a state of being worn on and close to a body part of the user. According to an embodiment, at least one of the right audio device 100a and the left audio device 100b may output an audio signal using wireless data transmission/reception with an electronic device. For example, a path of the wireless data transmission/reception may include at least one of a path for Bluetooth® communication scheme, a path for Bluetooth® low energy communication scheme, a path for ultra-wide band communication scheme, a path for wireless fidelity (Wi-Fi) direct communication scheme, and a path for mobile communication scheme (e.g., long term evolution (LTE) sidelink). According to an embodiment, only one of the pair of audio devices 100a and 100b may generate the communication path with the electronic device. For example, the electronic device may be connected to the right audio device 100a among the pair of audio devices 100a and 100b. The right audio device 100a may output an audio signal based on audio data of the electronic device received through the communication path.

In a case that the electronic device is connected to the right audio device 100a, the electronic device or the right audio device 100a may provide information on the communication path to the left audio device 100b so that the left audio device 100b may output the audio signal. The left audio device 100b may receive or sniff data transmitted to the right audio device 100a based on information on the communication path, and output the audio signal. For example, the left audio device 100b may receive data transmitted to the right audio device 100a by monitoring information on the communication path. According to an embodiment, the right audio device 100a connected to the electronic device may be referred to as a master device, and the left audio device 100b not connected to the electronic device may be referred to as a slave device. According to an embodiment, the master device and the slave device among the pair of audio devices 100a and 100b may be switched. According to an embodiment, at least one of the pair of audio devices 100a and 100b may transmit data to the electronic device. For example, the data may include information (e.g., information to play a sound source, information to pause a sound source, information to stop a sound source, information to control a volume (e.g., volume up, volume down), and information to select a sound source).

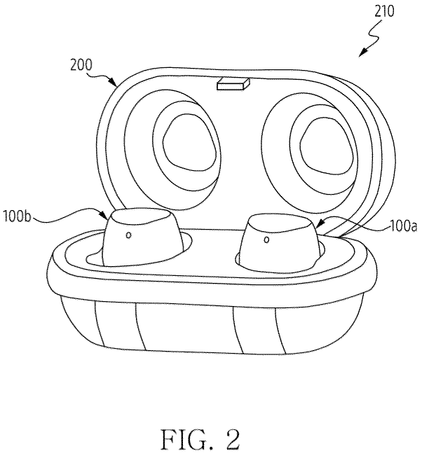

FIG. 2 illustrates an example of a state in which an audio device is connected to a power supply device, according to an embodiment.

In FIG. 2, a power supply device 200 may have an openable and closable structure. According to an embodiment, based on an operation of opening the power supply device 200, the power supply device 200 may perform a triggering operation for Bluetooth® pairing with the audio device 100. According to an embodiment, the audio device 100 may generally include a small-sized and rechargeable battery to provide mobility. Therefore, the audio device 100 may be connected to and stored in a separate power supply device 200 to prevent loss while the audio device 100 is not used. According to an embodiment, the audio device 100 may charge the battery, in a state of being connected to and stored in the power supply device 200.

According to an embodiment, the audio device 100 may include a detectable member corresponding to a sensor of the power supply device 200. For example, the power supply device 200 may include a hall sensor (or a hall integrated circuit (IC)), and the audio device 100 may include a magnet. According to an embodiment, in a case that the audio device 100 is accommodated in the power supply device 200, the hall sensor of the power supply device 200 may recognize a magnet installed in the audio device 100 and output a signal related to a combination of the power supply device 200 and the audio device 100.

According to an embodiment, the audio device 100 may include at least one conductive pin pad outside the audio device 100. According to an embodiment, the power supply device 200 may include at least one conductive pin (e.g., a conductive terminal) outside the power supply device 200. The conductive pin pad included in the audio device 100 and the conductive pin included in the power supply device 200 may be disposed to be physically contacted with each other in a state that the audio device 100 is connected to the power supply device 200. According to an embodiment, in a case that the audio device 100 is connected to the power supply device 200, the conductive pin pad of the audio device 100 and the conductive pin of the power supply device 200 may be in contact with each other to be electrically connected. According to an embodiment, the audio device 100 or the power supply device 200 may determine a connection state between the audio device 100 and the power supply device 200, by identifying the contact of the conductive pin.

According to an embodiment, the audio device 100 may determine whether the audio device 100 is connected to the power supply device 200, by sensing the amount of light reflected from the power supply device 200 through a proximity sensor. According to an embodiment, the accuracy of sensing an object close to the audio device 100 may be improved by treating a reflective structure of the power supply device 200 with a color having a high reflectivity. According to an embodiment, in a case that the power supply device 200 is configured with various colors, the power supply device 200 may be configured such that the color of the power supply device 200 and the color of the reflective structure of the power supply device 200 are visually identical or similar by adjusting transmittance of a filter. According to an embodiment, the audio device 100 may distinguish a sensing result value for the power supply device 200 and a user, by adjusting the power of the proximity sensor of the audio device 100 and performing proximity sensing.

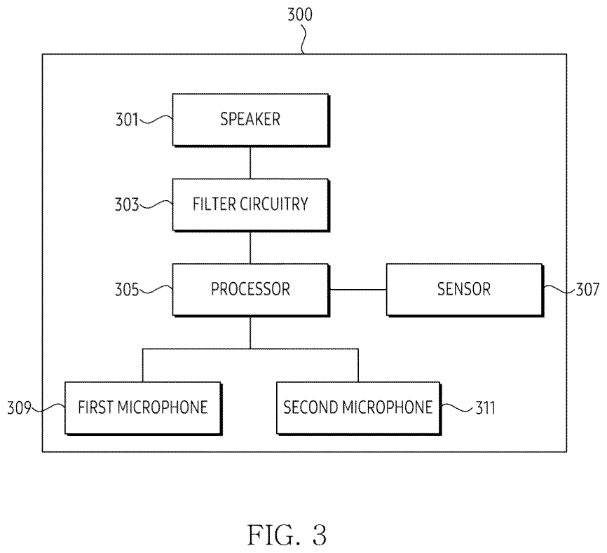

FIG. 3 illustrates components of an audio device, according to an embodiment. A configuration exemplified in FIG. 3 may be understood as a configuration of an audio device (e.g., a right audio device 100a or a left audio device 100b), as illustrated in FIG. 1.

In FIG. 3, an audio device 300 (e.g., the audio device 100, the right audio device 100a, and the left audio device 100b of FIG. 1) may include a speaker 301, filter circuitry 303, a processor 305, a sensor 307, a first microphone 309, and a second microphone 311. According to an embodiment, the audio device 300 may include a plurality of electronic components disposed in an internal space. The disclosure is not limited to the above embodiment. That is, electronic components other than the above electronic components may be further included. According to an embodiment, the audio device 300 may be an electronic device for outputting an audio signal. For example, the audio device 300 may be a wired earphone. For example, the audio device 300 may be a true wireless stereo (TWS) earphone.

According to an embodiment, the audio device 300 may include a speaker 301 that may output an audio signal. The speaker 301 may receive an electrical signal. The speaker 301 may include an element for obtaining an electrical signal. The speaker 301 may convert an electrical signal into a sound wave signal. The speaker 301 may include an element for converting an electrical signal into a sound wave signal. The speaker 301 may output an audio signal including a converted sound wave signal. The speaker 301 may include an element for outputting the audio signal.

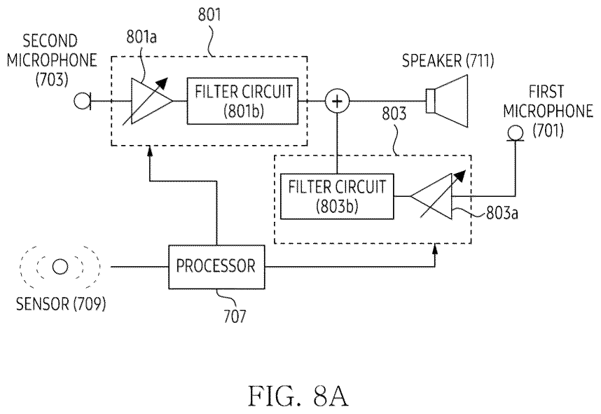

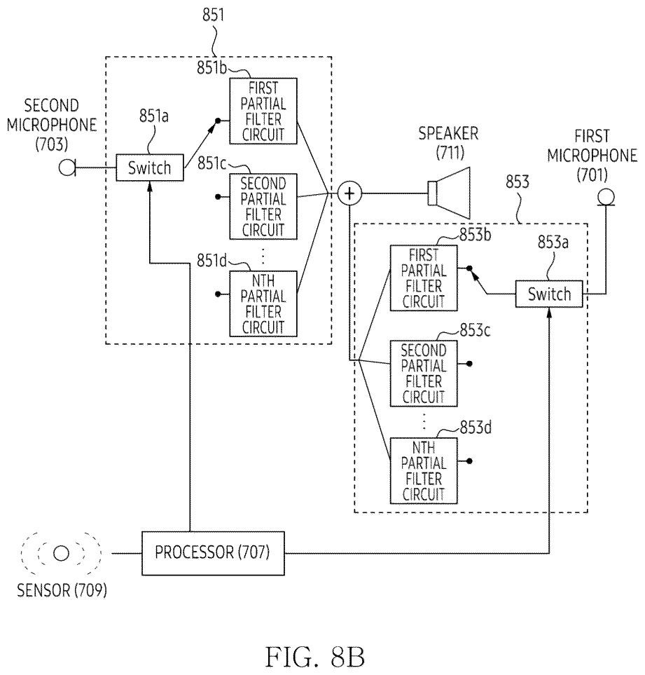

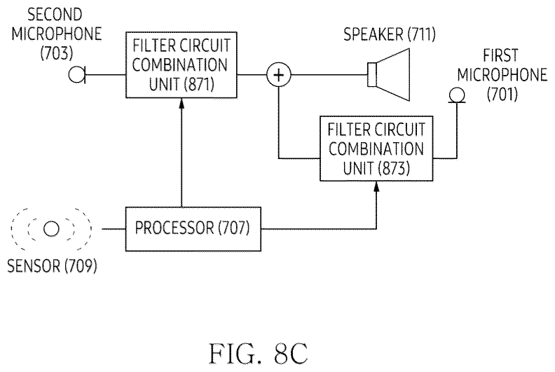

According to an embodiment, the filter circuitry 303 may be configured to adjust the intensity of an output signal according to a frequency of an input signal. A ratio of the intensity of the input signal to the intensity of the output signal may be determined based on a gain of the filter circuitry 303. Therefore, the intensity of the output signal may be determined based on the gain of the filter circuitry 303. Since the gain of the filter circuitry may vary based on a frequency of the input signal, the intensity of the output signal may vary based on the frequency. According to embodiments, at least one processor 305 may change the gain of the filter circuitry 303 by changing a characteristic of a plurality of partial filter circuits of the filter circuitry 303. The filter circuitry 303 may include a plurality of partial circuits. According to an embodiment, in order to change a gain of the filter circuitry 303 based on a frequency, the at least one processor may activate at least one of a plurality of partial filter circuits and deactivate at least another one. According to an embodiment, in order to change a gain of the filter circuitry 303 based on a frequency, the at least one processor may change a weight of each of the plurality of partial filter circuits. Hereinafter, FIG. 8A, FIG. 8B, and FIG. 8C illustrate a method of changing a gain of the filter circuitry based on a change in a characteristic of a plurality of partial filter circuits.

According to an embodiment, the audio device 300 may include a processor 305. The processor 305 may be implemented with one or more integrated circuit (IC) chips and may execute various data processes. For example, the processor 305 may be implemented as a system-on-chip (SoC). The processor 305 may include a central processing unit (CPU), a graphics processing unit (GPU), a neural processing unit (NPU), an image signal processor (ISP), a display controller, a memory controller, a storage controller, an application processor (AP), a communication processor (CP), and/or sub-components including a sensor interface. The sub-components are only exemplary. For example, the processor 305 may further include other sub-components. For example, some sub-components may be omitted from the processor 305.

According to embodiments, the processor 305 may detect a wearing state through a sensor 307 to be described later. The processor 305 may control components according to the wearing state of the audio device 300. The processor 305 may output an audio signal through the speaker 301. According to an embodiment, the processor 305 may receive audio data from an external device (e.g., server, smartphone, PC, PDA, or access point). The processor 305 may be designed to store the received audio data in memory. For example, the processor 305 may receive nonvolatile audio data (or download audio data) from an external device. The processor 305 may store the received nonvolatile audio data in a nonvolatile memory. Also, for example, the processor 305 may receive volatile audio data (or streaming audio data) from an external device. The processor 305 may store the received volatile audio data in a volatile memory. The processor 305 may reproduce audio data (e.g., nonvolatile audio data or volatile audio data) stored in the memory and output it through the speaker 301. The processor 305 may obtain an audio signal by decoding audio data (audio data reproduction), and output the obtained audio signal through the speaker 301.

According to an embodiment, the audio device 300 may include the sensor 307. The sensor 307 may receive physical data related to the audio device 300. For example, the sensor 307 may receive data related to a wearing state of the audio device 300. For example, the sensor 307 may identify the presence or absence of a touch input inputted to the audio device 300. For example, the sensor 307 may identify a pressure of a touch input inputted to the audio device 300. The sensor 330 may convert measured or detected information into an electrical signal. The sensor 307 may provide various information to the processor 305 according to a type of the sensor. According to an embodiment, the sensor 307 may include a touch sensor (a touch detection sensor). The sensor 307 may detect a user's touch input. The sensor 307 may provide a result of detecting the touch input to the processor 305. According to an embodiment, the sensor 307 may include a grip detection sensor. The sensor 307 may detect a user's grip. The sensor 307 may provide a result of detecting the grip to the processor 305. According to an embodiment, the sensor 307 may include a pressure sensor. The sensor 307 may detect pressure caused by a user or an external object. The sensor 307 may provide a result of detecting the pressure to the processor 305.

The information provided by the sensor 307 may be used by the processor 305 to perform various operations. The processor 305 may identify whether the audio device 300 is connected to the power supply device 200 based on the information obtained from the sensor 307. According to an embodiment, the processor 305 may identify whether the audio device 300 is worn on and close to a part of the user's body based on the information obtained from the sensor 307. According to an embodiment, the processor 305 may identify whether the wearing state of the audio device 300 has been changed based on the information obtained from the sensor 307.

According to an embodiment, the audio device 300 may include a first microphone 309 and a second microphone 311. The audio device 300 may include the first microphone 309. For example, the first microphone 309 may be disposed in an area of a protrusion unit (a protrusion part) of the audio device 300. The first microphone 309 may be referred to as a feedback microphone because the audio device 300 is disposed adjacent to the speaker when worn by the user. Also, the first microphone 309 may be referred to as an error microphone. The audio device 300 may include the second microphone 311. Also, for example, the second microphone 311 may be disposed in an area of a housing, which includes a sensor (e.g., the sensor 307) of the audio device 300. The second microphone 311 may be referred to as a feedforward microphone because the audio device 300 is disposed toward the outside when worn by the user. Also, the second microphone 311 may be referred to as a reference microphone.

The first microphone 309 may receive a noise signal to adjust an audio signal. The second microphone 311 may receive an external signal to adjust an audio signal. For example, the first microphone 309 may be used in an active noise cancellation (ANC) function for removing external noise. For example, the second microphone 311 may be used in an ANC function for removing external noise. In order to cancel the noise signal received from the first microphone 309 or the second microphone 311, the at least one processor (e.g., the processor 305) may generate a tuning signal. The tuning signal may be generated based on second phase information for canceling first phase information of the noise signal. For example, the second microphone 311 may be used in an ambient sound allowance function for hearing ambient sound or a ‘personal sound amplification products’ (PSAP) function. In order to amplify the external signal received from the second microphone, the at least one processor 305 may generate a tuning signal that may be generated based on second phase information for amplifying first phase information of the external signal. According to an amplification degree of the external signal received from the second microphone, the ambient sound allowance function and the PSAP function may be distinguished from each other. The ambient sound allowance function may include a surrounding sound listening function, an ambient function, a transparency function, and the like. In a case that the ambient sound allowance function is operated, the at least one processor 305 may amplify an external signal received from the second microphone to the intensity of a signal received by the user when the earbud is not worn. In a case that the PSAP function is operated, the at least one processor 305 may amplify an external signal received from the second microphone to the intensity of a signal received by the user when the earbud is not worn.

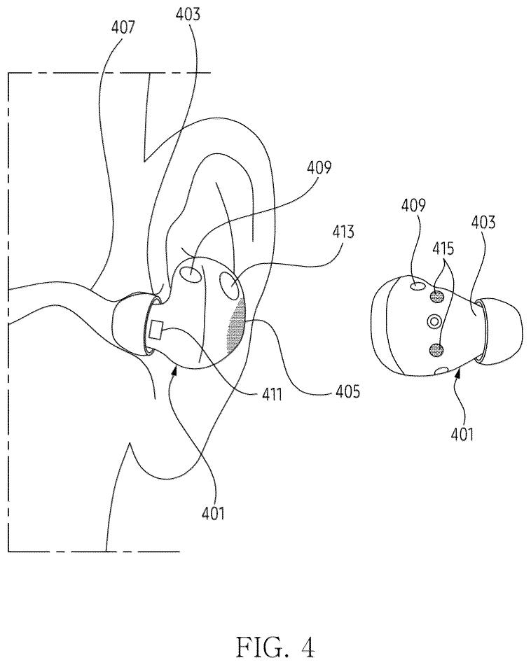

FIG. 4 illustrates an example of wearing an audio device, according to an embodiment.

In FIG. 4, an audio device 401 (e.g., the audio device 100 or the audio device 300) may be an electronic device for outputting an audio signal. A protrusion unit (a protrusion part) 403 may be a protruding structure for outputting an audio signal through a speaker (e.g., the speaker 301 of FIG. 3). A touch sensor 405 may detect a user's touch input. An external auditory canal 407 may be a passage through which an audio signal is propagated when the audio device 401 is worn. A speaker port 409 may be a ventilation hole for improving the performance of the speaker 301 by adjusting air pressure. An audio signal may also be transmitted through the speaker port 409. A first microphone 411 (e.g., the first microphone 309 of FIG. 3) may be a feedback microphone. The first microphone 411 may be referred to as an error microphone. A second microphone 413 (e.g., the second microphone 311 of FIG. 3) may be a feedforward microphone. The second microphone 413 may be referred to as a reference microphone. A charging terminal 415 may be a conductive pad corresponding to a conductive pin (e.g., a conductive terminal) of a power supply device (e.g., the power supply device 200 of FIG. 2).

The processor (e.g., the processor 305) may identify a user's touch input through the touch sensor 405. The processor 305 may control an operation of the audio device 401 based on the touch input. For example, the processor 305 may pause an audio signal being played in a case that a touch input is inputted to the touch sensor 405 once. For example, the processor 305 may play the paused audio signal again in a case that a touch input is inputted to the touch sensor 405 twice.

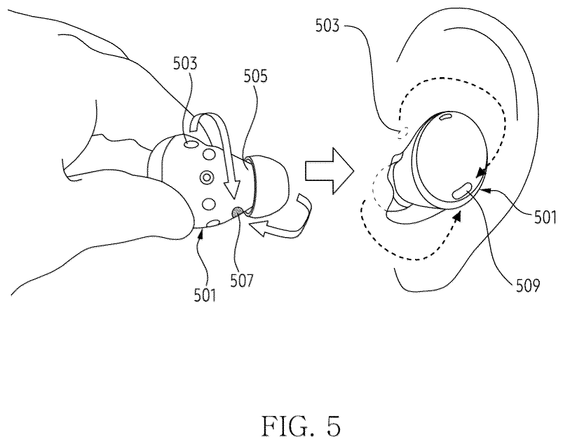

The speaker port 409 may be a ventilation hole for improving the performance of the speaker 301 by adjusting air pressure. According to an embodiment, since the performance of the speaker 301 varies according to a degree to which the speaker port 409 is blocked, howling may occur in a case that an ANC function for removing external noise is used. According to an embodiment, since the audio signal may also be transmitted through the speaker port 409, howling may occur in case of using an ambient sound allowance function for hearing ambient sound or a PSAP function. This is because the audio signal outputted from the speaker port 409 may flow back into the second microphone 413 and resonance may occur. The cause of howling in each function will be described in FIG. 5.

The first microphone 411 may be a feedback microphone disposed on a surface of the housing to which the protrusion unit is coupled. According to an embodiment, the first microphone 411 may be used in an ANC function for removing external noise. In order to cancel a noise signal received from the first microphone 411, the processor 305 may generate a tuning signal. The tuning signal may be generated based on second phase information for canceling first phase information of the noise signal. For example, the first phase information may be a phase of the noise signal. The second phase information may be a phase of the tuning signal. The phase of the tuning signal may be opposite to the phase of the noise signal. The second microphone 413 may be a reference microphone disposed on a surface of the housing to which the touch sensor 405 is coupled. According to an embodiment, the second microphone 413 may be used in an ANC function for removing external noise. In order to cancel a noise signal received from the second microphone 413, the processor 305 may generate a tuning signal. The tuning signal may be generated based on second phase information for canceling first phase information of the noise signal. For example, the first phase information may be a phase of the noise signal. The second phase information may be a phase of the tuning signal. The phase of the tuning signal may be opposite to the phase of the noise signal. According to an embodiment, the second microphone 413 may be used in an ambient sound allowance function for hearing ambient sound or a PSAP function. In order to amplify an external signal received from the second microphone 413, the processor 305 may generate a tuning signal. The tuning signal may be generated based on second phase information for amplifying first phase information of the external signal. For example, the first phase information may be a phase of the external signal. The second phase information may be a phase of the tuning signal. The phase of the tuning signal may be identical to the phase of the external signal.

The charging terminal 415 may be a conductive pad corresponding to a conductive pin (e.g., conductive terminal) of a power supply device (e.g., the power supply device 200 of FIG. 2). The audio device 401 may include at least one conductive pin pad externally. The power supply device 200 may include at least one conductive pin (e.g., conductive terminal) outside. The power supply device 200 may include at least one conductive pin (e.g., conductive terminal) outside. The conductive pin pad included in the audio device 401 and the conductive pin included in the power supply device 200 may be disposed to be physically contacted with each other in a state that the audio device 401 is connected to the power supply device 200. In a case that the audio device 401 is connected to the power supply device 200, the conductive pad of the audio device 401 and the conductive pin of the power supply device 200 may be contacted with each other to be electrically connected. By identifying the conductive pin contact, the audio device 401 or the power supply device 200 may determine a state in which the audio device 401 is connected to the power supply device 200.

FIG. 5 illustrates an example of movement of an audio device according to an embodiment. As an audio device (e.g., the audio device 100, the audio device 300, and the audio device 401) moves, an audio signal outputted from a speaker (e.g., the speaker 301) may be inputted to a microphone. For example, in a case that a signal outputted for the ANC function, the ambient sound allowance function, or the PSAP function is re-inputted through the microphone, a delayed signal may cause unintended constructive interference that may cause howling.

In FIG. 5, an audio device 501 (e.g., the audio device 300 and the audio device 401) may be an electronic device for outputting an audio signal. A speaker port 503 (e.g., the speaker port 409 of FIG. 4) may be a ventilation hole for improving the performance of the speaker 301 by adjusting air pressure. An audio signal of the audio device 501 may be emitted through the speaker port 503. A protrusion unit 505 (e.g., the protrusion unit 403 of FIG. 4) may be a protruding structure for the user's wearing and transmission of an audio signal.

The audio device 501 may include a first microphone 507 (e.g., the first microphone 309 of FIG. 3 and the first microphone 411 of FIG. 4). The first microphone 507 may be disposed on a surface of a housing, which includes the protrusion unit 505 of the audio device 501. The first microphone 507 may be referred to as a feedback microphone or an error microphone. The first microphone 507 may be used for an ANC function for removing external noise. The audio device 501 may include a second microphone 509 (e.g., the second microphone 311 of FIG. 3 and the second microphone 413 of FIG. 4). The second microphone 509 may be disposed on a surface of the housing, which includes a sensor of the audio device 501. The second microphone 509 may be referred to as a feedforward microphone or a reference microphone. The second microphone 509 may be used for the ANC function, an ambient sound allowance function, or a PSAP function.

According to an embodiment, howling may occur by the first microphone 507. At least one processor (e.g., the processor 305) may receive an audio signal outputted from a speaker in the protrusion unit 505 or an audio signal outputted from the speaker port 503, through the first microphone 507. The processor 305 may reduce the influence of howling by using filter circuitry. As an audio signal of a speaker flows into a microphone, howling may occur. A signal inflow characteristic may indicate a degree to which an audio signal of a speaker flows into the microphone. If the signal inflow characteristic is changed, setting of the filter circuitry for reducing the influence of howling is changed. The changed setting of the filter circuitry may cause howling again.

For example, an audio signal may be outputted from a speaker in the protrusion unit 505. The audio signal may be inputted to the first microphone 507. In order to reduce howling due to the input of the audio signal, the processor 305 may determine a characteristic of filter circuitry optimized according to a signal inflow characteristic. The processor 305 may reduce the intensity of a signal of a frequency at which howling is easily to occur, through the filter circuitry. The characteristic of the filter circuitry may be a gain according to a frequency. Therefore, in a general wearing state, even if an audio signal outputted from a speaker in the protrusion unit 505 is inputted to the first microphone 507, howling may not occur.

However, if the wearing state is changed, howling may occur. For example, in a case that a user's touch input is detected in the audio device 501, a clogging amount of the speaker port may vary. Due to a change in the clogging amount of the speaker port, air pressure in the audio device 501 may vary. A change in the air pressure may change a signal inflow characteristic to a microphone. In addition, for example, in a case that a user's touch input is detected in the audio device 501, a change in external auditory canal volume may occur. In addition, for example, in a case that pressure caused by a user's grip or an external object is detected in the audio device 501, a clogging amount of the speaker port may vary. Due to a change in the clogging amount of the speaker port, a signal inflow characteristic may vary. In addition, for example, in a case that pressure caused by a user's grip or an external object is detected in the audio device 501, a change in the external auditory canal volume may occur. Due to the change in the external auditory canal volume, the signal inflow characteristic may vary. As the signal inflow characteristic is changed, it may be difficult to reduce howling of the audio device 501 in which the wearing state has been changed in the setting of the filter circuitry before the wearing state is changed. Therefore, if the wearing state is changed, howling may occur again due to a change in the clogging amount of the speaker port or the external auditory canal volume.

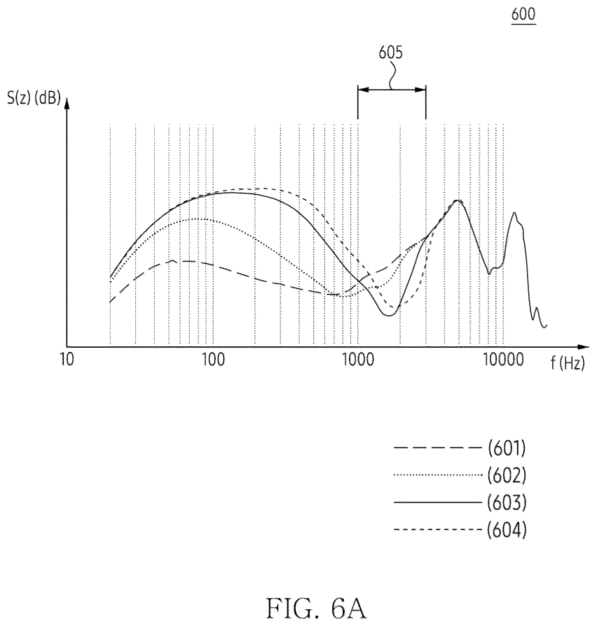

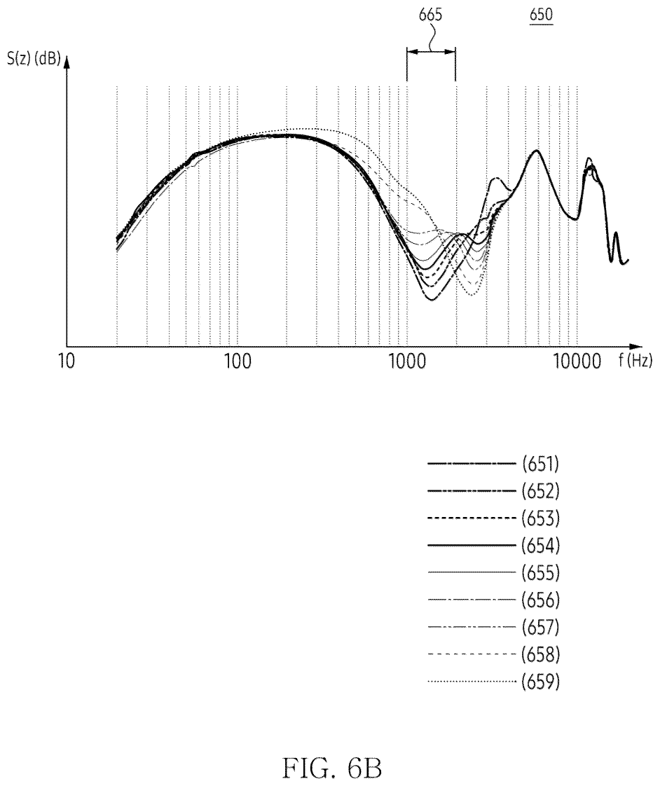

For example, an audio signal may be emitted from the speaker port 503. The audio signal may be introduced into the first microphone 507. In order to reduce howling due to the input of the audio signal, the processor 305 may determine a characteristic of filter circuitry optimized according to a signal inflow characteristic. Through the filter circuitry, the processor 305 may reduce the intensity of a signal of a frequency at which howling is easily to occur. The characteristic of the filter circuit may be a gain according to a frequency. Therefore, in a general wearing state, even if an audio signal outputted from the speaker port 503 is inputted to the first microphone 507, howling may not occur. However, if the wearing state is changed, howling may occur. For example, in a case that a user's touch input is detected in the audio device 501, a clogging amount of the speaker port may vary. The signal inflow characteristic may vary due to a change in the clogging amount of the speaker port. In addition, for example, in a case that pressure caused by a user's grip or an external object is detected in the audio device 501, a clogging amount of the speaker port may vary. Due to a change in the clogging amount of the speaker port, a signal inflow characteristic may vary. As the signal inflow characteristic is changed, it is difficult to reduce howling of the audio device 501 in which the wearing state has been changed in the setting of the filter circuitry before the wearing state is changed. Therefore, if the wearing state is changed, howling may occur again due to a change in the clogging amount of the speaker port or the external auditory canal volume. Hereinafter, in FIG. 6A, a relationship between the speaker port clogging amount and the signal inflow characteristic will be described. Hereinafter, in FIG. 6B, a relationship between the external auditory canal volume and the signal inflow characteristics will be described.

According to embodiments, howling may occur by the second microphone 509. As with the first microphone 507, if an audio signal outputted from a speaker in the protrusion unit 505 or an audio signal outputted from the speaker port 503 is inputted to the second microphone 509, howling may occur. As the audio signal of the speaker flows into a microphone, howling may occur. A signal inflow characteristic may indicate a degree to which an audio signal of a speaker flows into the microphone. If the signal inflow characteristic is changed, setting of the filter circuitry for reducing the influence of howling is changed. The changed setting of the filter circuitry may cause howling again.

According to an embodiment, due to a structure of the audio device 501, an audio signal outputted from a speaker in the protrusion unit 505 may be difficult to be inputted to the second microphone 509. Therefore, howling may not occur in the general wearing state. However, in a case that the wearing state of the audio device 501 is adjusted or the audio device 501 is touched for touch input, a degree of covering of the speaker is changed, so the signal inflow characteristic may vary. In a case that the wearing state of the audio device 501 is adjusted, a signal inflow characteristic may vary. That is, an audio signal outputted from a speaker in the protrusion unit 505 is inputted to the second microphone 509, and thus howling may occur.

According to an embodiment, due to the structure of the audio device 501, the audio signal outputted from the speaker port 503 may be difficult to be inputted to the second microphone 509. Therefore, howling may not occur in the general wearing state. However, if the wearing state is changed, howling may occur. For example, in a case that a user's touch input is detected in the audio device 501, the amount of covering of the speaker port may vary.

In a case that the wearing state of the audio device 501 is adjusted or the audio device 501 is touched for a touch input, since a degree of covering of the speaker port 503 is changed, a signal inflow characteristic may vary. In a case that the wearing state of the audio device 501 is adjusted, a signal inflow characteristic may vary. That is, the audio signal outputted from the speaker port 503 is inputted to the second microphone 509, and thus howling may occur.

FIG. 6A illustrates an example of a signal inflow characteristic through a secondary path according to a clogging amount of a speaker port.

In FIG. 6A, a graph 600 may represent a signal inflow characteristic through a secondary path according to a clogging amount of a speaker port (e.g., the speaker port 409 of FIG. 4 and the speaker port 503 of FIG. 5). A horizontal axis of the graph 600 represents a frequency (unit: hertz (Hz)) and a vertical axis of the graph 600 represents a gain (unit: decibel (dB)). The air pressure in the audio device 501 may vary due to a change in the clogging amount of the speaker port. The change in air pressure may change the signal inflow characteristic to a microphone. For example, the signal inflow characteristic through the secondary path may be obtained based on a ratio of the intensity of a reception signal with respect to the intensity of a transmission signal.

A signal inflow characteristic through a primary path may be a result of comparing a signal received through a first microphone and a signal received through a second microphone. A signal inflow characteristic through a secondary path may be obtained by inputting an audio signal of a speaker into the first microphone. Hereinafter, a signal inflow characteristic refers to a signal inflow characteristic through the secondary path.

Data 601 is a signal inflow characteristic according to a frequency measured in a case that a speaker port clogging amount is about 100%. Data 602 is a signal inflow characteristic according to a frequency measured in a case that a speaker port clogging amount is about 90%. Data 603 is a signal inflow characteristic according to a frequency measured in a case that a speaker port clogging amount is about 70%. Data 604 is a signal inflow characteristic according to a frequency measured in a case that a speaker port clogging amount is a default value (e.g., 10%).

As the speaker port clogging amount increases, it may be confirmed that a signal inflow characteristic of a frequency section 605 increases. A higher frequency has a shorter wavelength, and thus an influence caused by a time delay of an inflow signal increases. Therefore, it may be difficult to remove external noise by an ANC function. In particular, at frequencies above 1000 Hz, it may be difficult to remove external noise by the ANC function, and howling is likely to occur. As the speaker port clogging amount increases, an audio device (e.g., the audio device 501) may reduce howling by filtering the audio signal in the frequency section 605 through filter circuitry. For example, as the speaker port clogging amount increases, the audio device 501 may reduce a gain for a specific frequency range (e.g., about 1000˜3000Hz) of an input signal through the filter circuitry at the frequency section 605.

In a case that a wearing state of the audio device 501 is adjusted or the audio device 501 is touched for a touch input, the speaker port clogging amount may change. Therefore, in order to prevent howling, in a case that a touch input is identified by a wearing detection sensor (e.g., the touch sensor 405 of FIG. 4), the audio device 501 may identify the touch input as a change in the speaker port clogging amount. Therefore, the audio device 501 may reduce a gain of the filter circuitry at the frequency section 605.

FIG. 6B illustrates an example of a signal inflow characteristic according to a volume of external auditory canal.

In FIG. 6B, a graph 650 may represent a signal inflow characteristic according to a volume of external auditory canal (e.g., the external auditory canal 407 of FIG. 4). A horizontal axis of the graph 650 represents a frequency (unit: hertz (Hz)), and a vertical axis of the graph 650 represents a signal inflow characteristic (unit: decibel (dB)). If the volume of the external auditory canal is changed, a resonant frequency for the audio device 501 may be changed. For example, if the volume of the external auditory canal increases, the resonant frequency may also increase. A change in the resonant frequency may change a signal inflow characteristic. For example, the signal inflow characteristic may be obtained based on a ratio of the intensity of a reception signal with respect to the intensity of a transmission signal.

Data 651 is a signal inflow characteristic according to a frequency measured when the external auditory canal volume is the largest. Data 651, data 652, data 653, data 654, data 655, data 656, data 657, data 658, and data 659, in order, are signal inflow characteristics according to a frequency measured when the external auditory canal volume is large. Data 659 is a signal inflow characteristic according to a frequency measured when the external auditory canal volume is the smallest. It may be confirmed that the signal inflow characteristic of the frequency range 665 increases as the external auditory canal volume decreases. The higher the frequency, the shorter the wavelength. The shorter wavelength may be greatly affected by time delay, and thus, it may be difficult to remove external noise by using the ANC function. In particular, at frequencies above 1000 Hz, it may be difficult to remove external noise by the ANC function, and howling is likely to occur. Therefore, the audio device 501 may reduce howling by filtering an audio signal of the frequency range 665 through the filter circuitry as the external auditory canal volume decreases. For example, the audio device 501 may reduce a gain for a specific frequency range (e.g., about 1000˜3000 Hz) of an input signal, through the filter circuitry at the frequency range 665 as the external auditory canal volume decreases.

In a case that a wearing state of the audio device 501 is adjusted or the audio device 501 is touched for a touch input, the external auditory canal volume may be changed. In particular, when a touch input occurs, the audio device 501 is pushed into the external auditory canal, so the external auditory canal volume may decrease. Therefore, in order to prevent howling, the audio device 501 may identify that the external auditory canal volume has been changed when a touch input is identified by a wearing detection sensor (e.g., the touch sensor 405 of FIG. 4). Therefore, in a case that the touch input is identified, the audio device 501 may reduce a gain of the filter circuitry at the frequency range 665.

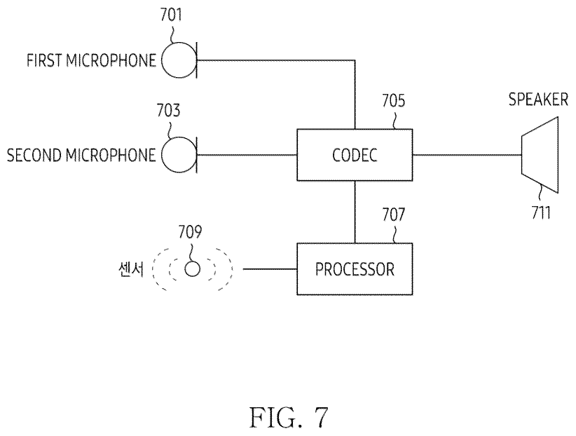

As described above, howling may occur when a signal inflow characteristic is changed by operations such as receiving a touch input or adjusting a wearing state. In order to reduce the influence of howling even if the signal inflow characteristic is changed, the audio device 501 according to the embodiments may change setting of the filter circuitry to reduce a signal gain within a frequency range causing howling. Hereinafter, a method of changing the setting of the filter circuitry will be described in FIGS. 7, 8A, and 8B.

FIG. 7 illustrates a functional configuration of an audio device, according to an embodiment.

In FIG. 7, an audio device (e.g., the audio device 501) may include a first microphone 701, a second microphone 703, and a speaker 711. The first microphone 701 may receive noise for ANC in the audio device 501. In addition, the first microphone 701 may be positioned adjacent to the speaker 711 of the audio device 501 to receive output of the speaker 711. The first microphone 701 may be referred to as a feedback microphone or an error microphone. The second microphone 703 may receive noise for ANC or receive ambient sound for an ambient sound allowance function or a PSAP. In addition, the second microphone 703 may be positioned adjacent to a sensor of the audio device 501 to receive a signal from outside the audio device 501. The second microphone 703 may be referred to as a feedforward microphone or a reference microphone. The speaker 711 may transmit an audio signal.

The audio device 501 may include a codec 705 that refers to a component (e.g., encoder, decoder) for converting a digital signal into a voice signal or converting a voice signal into a digital signal. The codec 705 may change setting of a filter of the codec 705, based on a control signal from the processor 707.

The audio device 501 may include a processor 707 that may transmit a control signal for changing the setting of the filter to the codec 705, based on a detection result from a sensor 709. The audio device 501 may include the sensor 709. According to an embodiment, the sensor 709 may be configured to detect a touch input. The processor 707 may identify a change in a wearing state of the audio device based on the touch input. In addition, according to an embodiment, the sensor 709 may be configured to detect a user's grip. The processor 707 may identify a change in the wearing state of the audio device based on the grip. In addition, according to an embodiment, the sensor 709 may be configured to measure external pressure. The processor 707 may identify a change in the wearing state of the audio device based on the external pressure.

In a case that an audio signal outputted from the speaker 711 is inputted to the first microphone 701 or the second microphone 703 and is outputted again through the speaker 711, howling may occur. Therefore, in order to prevent howling, the processor 707 may adjust a signal transmitted to the speaker 711, based on the change in the wearing state. The processor 707 may adjust the signal transmitted to the speaker 711 through the codec 705. The codec 705 adjusts the signal transmitted to the speaker 711 by changing a gain of filter circuitry included in the codec 705.

As illustrated in FIGS. 6A and 6B, in a case of the change in the wearing state identified based on the touch input, the intensity of an audio signal in a frequency section vulnerable to howling may increase. Therefore, by lowering the gain of the signal received through the microphone in the frequency range vulnerable to the howling, howling may be prevented. Hereinafter, a method of changing setting of the filter circuitry to lower a gain of a signal within the frequency range will be described in FIGS. 8A, 8B, and 8C.

FIG. 8A illustrates an example of a functional configuration of an audio device including a filter circuitry combination unit according to an embodiment.

In FIG. 8A, an audio device (e.g., the audio device 501) may include a first microphone 701, a second microphone 703, and a speaker 711. For the first microphone 701, the second microphone 703, and the speaker 711, the description of FIG. 7 may be referenced.

The audio device 501 may filter an audio signal according to a frequency. For example, a codec (e.g., the codec 705 of FIG. 7) of the audio device 501 may include a first filter circuit unit 801 and a second filter circuit unit 803.

The audio device 501 may include the first filter circuit unit 801 that includes a first amplifier 801a and a first filter circuit 801b. The first amplifier 801a may control a gain of an input signal. For example, the first amplifier 801a may reduce a gain of a signal. The first filter circuit 801b may filter a signal in a specific frequency range from the signal. The first filter circuit 801b may perform filtering so that the intensity of a signal in a specified range in which howling is expected is lowered. The first filter circuit unit 801 may filter an audio signal received through a second microphone 703 according to a frequency, while the ANC function, the ambient sound allowance function, or the PSAP function is performed. As a signal is filtered at a specific frequency, howling may be reduced.

The audio device 501 may include a second filter circuit unit 803 that may include a second amplifier 803a and a second filter circuit 803b. The second amplifier 803a may control a gain of an input signal. For example, the second amplifier 803a may reduce a gain of a signal. The second filter circuit 803b may filter a signal in a specific frequency range from the signal. For example, the second filter circuit 803b may perform filtering so that the intensity of a signal in a specified range in which howling is expected is lowered. The second filter circuit unit 803 may filter an audio signal received through the first microphone 701 according to a frequency, while an ANC function is performed. As the signal is filtered at a specific frequency, howling may be reduced.

According to an embodiment, the processor 707 may receive a detecting result through the sensor 709. According to an embodiment, the sensor 709 may detect a user's touch input through a touch sensor. According to an embodiment, the sensor 709 may detect a grip through a grip detection sensor. According to an embodiment, the sensor 709 may detect pressure of an external object or a user through a pressure sensor.

The processor 707 may identify a change in the wearing state of the audio device 501 based on the detecting result. As the wearing state of the audio device 501 changes, a signal inflow characteristic may vary. Due to the varied signal inflow characteristic, an audio signal outputted from the speaker 711 may be inputted to the first microphone 701 or the second microphone 703. As the inputted audio signal is outputted again through the speaker 711, howling may occur. Therefore, in order to prevent howling, the processor 707 may adjust a characteristic of the audio signal outputted again through the speaker 711 based on the change in the wearing state.

According to an embodiment, the processor 707 may change a gain of the first filter circuit unit 801 as a whole. The processor 707 may change a gain of the first filter circuit unit 801 as a whole, regardless of the frequency. For example, the processor 707 may lower the gain of the first filter circuit unit 801 as a whole. According to an embodiment, the processor 707 may change the gain of the first filter circuit unit 801 according to a frequency. For example, the processor 707 may lower the gain of the first filter circuit unit 801 in a specific frequency range.

According to an embodiment, the processor 707 may change a gain of the second filter circuit unit 803 as a whole. The processor 707 may change the gain of the second filter circuit unit 803 as a whole, regardless of the frequency. For example, the processor 707 may lower the gain of the second filter circuit unit 803 as a whole. According to an embodiment, the processor 707 may change the gain of the second filter circuit unit 803 according to a frequency. For example, the processor 707 may lower the gain of the second filter circuit unit 803 in a specific frequency range.

FIG. 8B illustrates an example of a functional configuration of an audio device including partial filter circuits according to an embodiment. Unlike FIG. 8A, in FIG. 8B, the gain of the signal may be controlled by selecting partial filter circuits of the filter circuit unit instead of changing the gain of the entire filter circuit.

In FIG. 8B, an audio device (e.g., an audio device 501) may include a first microphone 701, a second microphone 703, and a speaker 711. For the first microphone 701, the second microphone 703, and the speaker 711, the description of FIG. 7 may be referenced.

The audio device 501 may filter an audio signal according to a frequency. For example, a codec (e.g., the codec 705 of FIG. 7) of the audio device 501 may include a first filter circuit unit 851 and a second filter circuit unit 853.

The audio device 501 may include a first filter circuit unit 851. The first filter circuit unit 851 may include a first switch 851a and partial filter circuits. The partial filter circuits may include a first partial filter circuit 851b, a second partial filter circuit 851c, . . . , a nth partial filter circuit 851d. The first switch 851a may connect one of the partial filter circuits. The first switch 851a may change a currently connected partial filter circuit among the partial filter circuits to another partial filter circuit, based on a control command from the processor 707. For example, the first switch 851a may change the connected partial filter circuit from the second partial filter circuit 851c to the first partial filter circuit 851b, based on the control command of the processor 707. The first filter circuit unit 851 may filter an audio signal received through the second microphone 703 according to a frequency while the ANC function, the ambient sound allowance function, or the PSAP function is performed. As a signal is filtered at a specific frequency, howling may be reduced.

The audio device 501 may include a second filter circuit unit 853 that may include a second switch 853a and partial filter circuits. The partial filter circuits may include a first partial filter circuit 853b, a second partial filter circuit 853c, . . . , a nth partial filter circuit 853d. The second switch 853a may connect one of the partial filter circuits. The second switch 853a may change a currently connected partial filter circuit among the partial filter circuits to another partial filter circuit, based on a control command of the processor 707. For example, the second switch 853a may change the connected partial filter circuit from the second partial filter circuit 853c to the first partial filter circuit 853b, based on the control command of the processor 707. The second filter circuit unit 853 may filter an audio signal received through the first microphone 701 according to a frequency while the ANC function is performed. As the signal is filtered at a specific frequency, howling may be reduced.

According to an embodiment, the processor 707 may switch a partial filter circuit to be used among the partial filter circuits of the first filter circuit unit 851 from a partial filter circuit to another partial filter circuit. Due to external inputs (e.g., touch input, grip detecting, pressure), a signal inflow characteristic may vary, and filtering frequencies and filtering gains provided from each partial filter circuit may be independent. For example, a filtering characteristic of the first partial filter circuit 851b and a filtering characteristic of the second partial filter circuit 851c may be different. The first partial filter circuit 851b may lower a pass gain for a signal in a first frequency range, while the second partial filter circuit 851c may lower a pass gain for a signal in a second frequency range. The processor 707 may identify a partial filter circuit so that a signal gain in a required frequency range is lowered. The processor 707 may connect the identified partial filter circuit to the second microphone 703 through the first switch 851a. In FIG. 8B, the first switch 851a is exemplified, but selection of the partial filter circuit may be implemented in another way. For example, the processor 707 may activate one of the partial filter circuits of the first filter circuit unit 851 and deactivate all remaining partial filter circuits of the first filter circuit unit 851.

According to an embodiment, the processor 707 may switch a partial filter circuit to be used among the partial filter circuits of the second filter circuit unit 853 from a partial filter circuit to another partial filter circuit. Due to external inputs (e.g., touch input, grip sensing, pressure), a signal inflow characteristic may vary, and filtering frequencies and filtering gains provided from each partial filter circuit may be independent.

For example, a filtering characteristic of the first partial filter circuit 853b and a filtering characteristic of the second partial filter circuit 853c may be different. The first partial filter circuit 853b may lower a pass gain for a signal in a first frequency range, while the second partial filter circuit 853c may lower a pass gain for a signal in a second frequency range. The processor 707 may identify a partial filter circuit so that a signal gain in a required frequency range is lowered. The processor 707 may connect the identified partial filter circuit to the second microphone 703 through a second switch 853a.

Although the second switch 853a is illustrated in FIG. 8B, selection of the partial filter circuit may be implemented in another way. For example, the processor 707 may activate one of the partial filter circuits of the second filter circuit unit 853 and deactivate all remaining partial filter circuits of the second filter circuit unit 853.

FIG. 8C illustrates an example of a functional configuration of an audio device including a filter circuitry combination unit according to an embodiment.

In FIG. 8C, an audio device (e.g., the audio device 501) may include a first microphone 701, a second microphone 703, and a speaker 711. For the first microphone 701, the second microphone 703, and the speaker 711, the description of FIG. 7 may be referenced.

The audio device 501 may filter an audio signal according to a frequency. For example, a codec (e.g., the codec 705 of FIG. 7) of the audio device 501 may include a first filter circuit combination unit 871 and a second filter circuit combination unit 873.

The audio device 501 may include a first filter circuit combination unit 871. The first filter circuit combination unit 871 may include a combination of a plurality of partial filter circuits. The partial filter circuits may include a first partial filter circuit, a second partial filter circuit, . . . , and a nth partial filter circuit. The first filter circuit combination unit 871 may be configured by changing a weight of each of the plurality of partial filter circuits based on a control command of the processor. For example, the first filter circuit combination unit 871 may be configured with a weight of the first partial filter circuit as 0.5, a weight of the second partial filter circuit as 0.3, and a weight of the third partial filter circuit as 0.2. The first filter circuit combination unit 871 may filter an audio signal received through the second microphone 703 according to a frequency while the ANC function, the ambient sound allowance function, or the PSAP function is performed. As a signal is filtered at a specific frequency, howling may be reduced.

The audio device 501 may include a second filter circuit combination unit 873. The second filter circuit combination unit 873 may include a combination of a plurality of partial filter circuits. The partial filter circuits may include a first partial filter circuit, a second partial filter circuit, . . . , and a nth partial filter circuit. The second filter circuit combination unit 873 may be configured by changing a weight of each of the plurality of partial filter circuits based on a control command of the processor. For example, the second filter circuit combination unit 873 may be configured with a weight of the first partial filter circuit as 0.5, a weight of the second partial filter circuit as 0.3, and a weight of the third partial filter circuit as 0.2. The second filter circuit combination unit 873 may filter an audio signal received through the first microphone 701 according to a frequency while the ANC function, the ambient sound allowance function, or the PSAP function is performed. As a signal is filtered at a specific frequency, howling may be reduced.

According to embodiments, the first filter circuit combination unit 871 and the second filter circuit combination unit 873 may be configured with a plurality of partial filter circuits. According to an embodiment, in the first filter circuit combination unit 871 and the second filter circuit combination unit 873, at least one of the plurality of partial filter circuits may be activated and at least another one may be deactivated. According to an embodiment, the first filter circuit combination unit 871 and the second filter circuit combination unit 873 may be configured to change a weight of each of the plurality of partial filter circuits. According to an embodiment, the first filter circuit combination unit 871 and the second filter circuit combination unit 873 may be configured to change a weight of each of the plurality of partial filter circuits. According to an embodiment, the first filter circuit combination unit 871 and the second filter circuit combination unit 873 may be a combination of the plurality of partial filter circuits. For example, in at least one processor, the greater the pressure of a touch input, the higher a frequency range at which a gain of the first filter circuit combination unit 871 and the second filter circuit combination unit 873 is lowered.

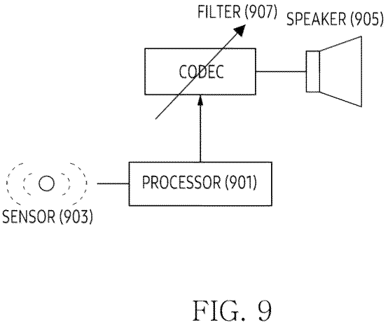

FIG. 9 illustrates an example of a functional configuration of an audio device for controlling a filter characteristic without a microphone, according to an embodiment.

In FIG. 9, an audio device (e.g., an audio device 501) may include a sensor 903, a processor 901, a codec 907 including filter circuitry, and a speaker 711. The processor 901 may change sound quality to improve the user experience even if an ANC, an ambient sound allowance function, or a PSAP function is not activated. The processor 901 may transmit a signal to the codec 907 to change the sound quality. The sensor 903 may detect an external input. For example, the sensor 903 may detect a touch input. For example, the sensor 903 may detect a touch pressure. The speaker 905 may transmit an audio signal. The codec 907 may change a gain of the filter. At least one processor (e.g., the processor 305 of FIG. 3) may identify a change in a wearing state, such as a speaker port clogging amount change or an external auditory canal volume change, based on identification of an external input received through a sensor. According to the change in the wearing state, the at least one processor 305 may change a gain according to a frequency of the filter through the codec 907. For example, the processor may increase a frequency range of filter circuitry having a low gain because the external auditory canal volume decreases as the intensity of the touch pressure increases.

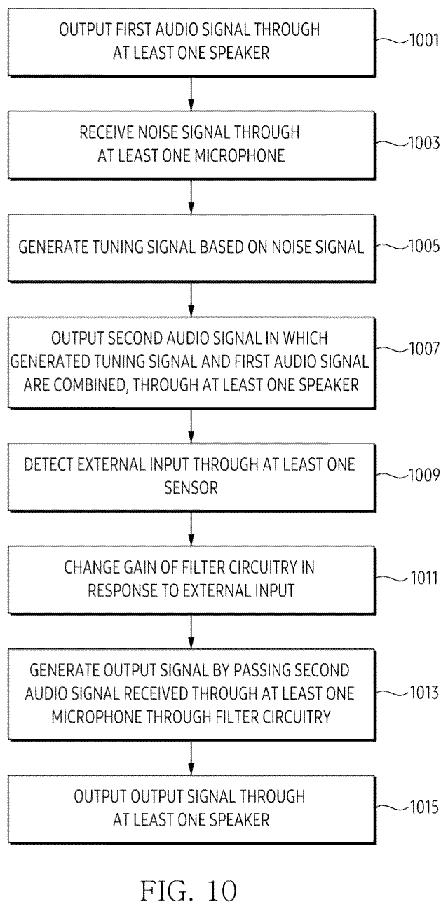

FIG. 10 illustrates an operation of an audio device for controlling an audio signal while an ANC is performed, according to an embodiment. The ANC is a function for providing a user with a better audio signal by removing external noise. The operation of an audio device (e.g., the audio device 300 and the audio device 501) may be performed by at least one processor (e.g., the processor 305).

In operation 1001, at least one processor (e.g., the processor 305 of FIG. 3) may output a first audio signal through at least one speaker.

In operation 1003, the at least one processor 305 may receive a noise signal through at least one microphone. The at least one microphone may be a first microphone (e.g., the first microphone 701 of FIG. 7). The at least one microphone may be a second microphone (e.g., the second microphone 703 of FIG. 7). According to an embodiment, the first microphone 701 or the second microphone 703 may be used in an ANC function for removing external noise.

In operation 1005, the at least one processor 305 may generate a tuning signal based on the noise signal. The tuning signal may be generated based on second phase information for canceling first phase information of the noise signal. The external noise may be removed through the cancellation. For example, the first phase information may be a phase of the noise signal. The second phase information may be a phase of the tuning signal. The phase of the tuning signal may be opposite to the phase of the noise signal.

In operation 1007, the at least one processor 305 may output a second audio signal in which the generated tuning signal and the first audio signal are combined, through the at least one speaker. The at least one processor 305 may remove external noise through the tuning signal. The at least one processor 305 may transmit the second audio signal to transmit the first audio signal from which the external noise has been removed.

In operation 1009, the processor 305 may detect an external input through at least one sensor. The processor 305 may identify a change in the wearing state of the audio device 501 based on the external input. The at least one sensor may be a sensor for detecting a touch. The at least one sensor may be a sensor for measuring pressure. The at least one sensor may be a sensor for detecting a grip. For example, the processor 305 may detect a touch input through a touch sensor. The processor 305 may identify a change in the wearing state of the audio device 501 based on the touch input. For example, the processor 305 may detect a pressure of the touch through a pressure sensor. For example, the processor 305 may detect a grip through a grip sensor.

In operation 1009, the processor 305 may change a gain of filter circuitry based on the external input. For example, the at least one processor 305 may lower the gain of the filter circuitry based on the touch input. In a case that a change in the wearing state is identified based on the touch input, the intensity of an audio signal in a frequency range vulnerable to howling may increase. Accordingly, the at least one processor 305 may prevent howling by lowering the gain of the filter circuitry in the frequency range vulnerable to howling. The change in the wearing state affecting the intensity of the audio signal may include a change in the speaker port clogging amount, a change in the external auditory canal volume, and the like. The processor 305 may determine the change in the wearing state through whether an external input is received through the sensor. The processor 305 may receive an external input through the sensor. The processor 305 may identify a change in the wearing state of the audio device 501 based on the reception of the touch input. In a case that an audio signal outputted from a speaker is inputted into the first microphone or the second microphone and is outputted again through the speaker, howling may occur. Therefore, in order to prevent howling, the processor 305 may adjust a signal transmitted to the speaker based on the change in the wearing state.

For example, the processor 305 may lower a gain of the filter circuitry in a specific frequency range based on identification of the external input. For example, the filter circuitry may be switched from a partial filter circuit of a plurality of partial filter circuits to another partial filter circuit. For example, the processor 305 may activate a partial filter circuit of the plurality of partial filter circuits and deactivate all remaining partial filter circuits. For example, in the filter circuit combination unit, at least one partial filter circuit of the plurality of partial filter circuits may be activated and at least another partial filter circuit may be deactivated. For example, the filter circuit combination unit may be configured to change a weight of each of the plurality of partial filter circuits. For example, the filter circuit combination unit may be configured to change a weight of each of the plurality of partial filter circuits.

In operation 1013, the at least one processor 305 may generate an output signal by passing the second audio signal received through the at least one microphone through the filter circuitry.

In operation 1015, the at least one processor 305 may output an output signal through the at least one speaker. The processor 305 reduces a gain in a frequency range vulnerable to howling when the wearing state is changed, in order to prevent howling of the output signal from occurring. Therefore, howling may not occur even if the speaker port clogging amount is changed or the external auditory canal volume is changed.

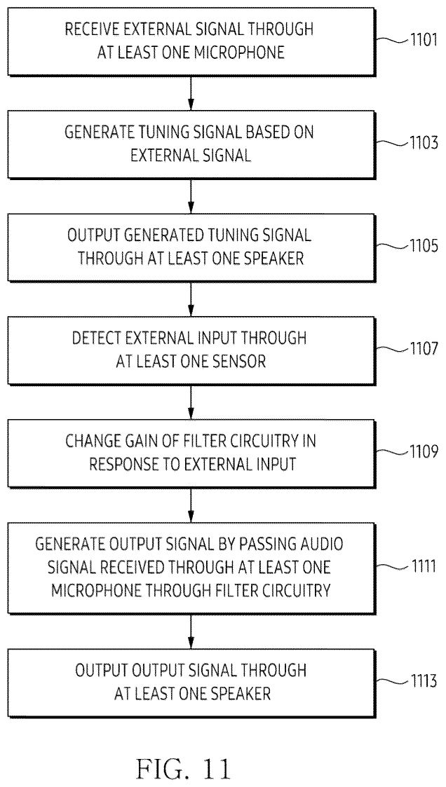

FIG. 11 illustrates an operation of an audio device for controlling an audio signal while an ambient sound allowance function for hearing ambient sound or a PSAP function is performed, according to an embodiment.

In operation 1101, at least one processor 305 may receive an external signal through at least one microphone. The microphone may be a second microphone (e.g., the second microphone 703 of FIG. 7). According to an embodiment, the second microphone 413 may be used in an ambient sound allowance function for hearing ambient sound or a PSAP function.

In operation 1103, the at least one processor 305 may generate a tuning signal based on the external signal. According to an embodiment, the at least one processor may generate a tuning signal to amplify the external signal received from the second microphone 413. The tuning signal may be generated based on second phase information for amplifying first phase information of the external signal. Through amplification, ambient sound may be heard by the wearer, for example, the first phase information may be a phase of the external signal. The second phase information may be a phase of the tuning signal. The phase of the tuning signal may be identical to the phase of the external signal.

In operation 1105, the at least one processor 305 may output the generated tuning signal through the at least one speaker.

In operation 1107, the at least one processor 305 may detect an external input through at least one sensor. The processor 305 may identify a change in the wearing state of an audio device (e.g., the audio device 501 of FIG. 5) based on the external input. The at least one sensor may be a sensor for detecting a touch. The at least one sensor may be a sensor for measuring pressure. The at least one sensor may be a sensor for detecting a grip. For example, the processor 305 may detect a touch input through a touch sensor. The processor 305 may identify a change in the wearing state of the audio device 501 based on the touch input. For example, the processor 305 may detect a pressure of the touch through a pressure sensor. For example, the processor 305 may detect a grip through a grip sensor.

In operation 1109, the at least one processor 305 may change a gain of filter circuitry based on the external input. For example, the at least one processor 305 may lower the gain of the filter circuitry based on the touch input. In a case that a change in the wearing state is identified based on the touch input, the intensity of an audio signal in a frequency range vulnerable to howling may increase. Therefore, the at least one processor 305 may prevent howling by lowering the gain of the filter circuitry in the frequency range vulnerable to the howling. The change in the wearing state affecting the intensity of the audio signal may include a change in the speaker port clogging amount, a change in the external auditory canal volume, and the like. The processor 305 may determine this change in the wearing state through whether an external input is received through the sensor. The processor 305 may receive an external input through the sensor. The processor 305 may identify a change in the wearing state of the audio device 501 based on the reception of the touch input. In a case that an audio signal outputted from a speaker is inputted into the first microphone or the second microphone and is outputted again through the speaker, howling may occur. Therefore, in order to prevent howling, the processor 305 may adjust the signal transmitted to the speaker based on the change in the wearing state.

For example, the processor 305 may lower a gain of the filter circuitry in a specific frequency range based on external input identification. For example, the filter circuitry may be switched from a partial filter circuit among a plurality of partial filter circuits to another partial filter circuit. For example, the processor 305 may activate a partial filter circuit among the plurality of partial filter circuits and deactivate all of the remaining partial filter circuits. For example, the filter circuit combination unit may activate at least one partial filter circuit among the plurality of partial filter circuits and deactivate at least another partial filter circuit. For example, the filter circuit combination unit may be configured to change a weight of each of the plurality of partial filter circuits. The filter circuit combination unit may be configured to change a weight of each of the plurality of partial filter circuits.

In operation 1111, the at least one processor 305 may generate an output signal by passing the audio signal received through the at least one microphone through the filter circuitry.

In operation 1113, the at least one processor 305 may output an output signal through the at least one speaker. The processor 305 reduces a gain in a frequency range vulnerable to howling when the wearing state is changed, in order to prevent howling of the output signal from occurring. Therefore, howling may not occur even if the speaker port clogging amount is changed or the external auditory canal volume is changed.

As described above, according to an embodiment, an audio device may comprise at least one processor, at least one speaker, at least one microphone, filter circuitry, and at least one sensor. The at least one processor may be configured to output a first audio signal through the at least one speaker. The at least one processor may be configured to receive a noise signal through the at least one microphone. The at least one processor may be configured to generate a tuning signal based on the noise signal. The at least one processor may be configured to output a second audio signal, in which the generated tuning signal and the first audio signal are combined, through the at least one speaker. The at least one processor may be configured to detect an external input through the at least one sensor. The at least one processor may be configured to change a gain of the filter circuitry based on the external input. The at least one processor may be configured to generate an output signal by passing the second audio signal received through the at least one microphone, through the filter circuitry of which the gain has been changed. The at least one processor may be configured to output the output signal through the at least one speaker.

According to an embodiment, in order to change the gain of the filter circuitry, the at least one processor may be configured to activate at least one partial filter circuit of a plurality of partial filter circuits of the filter circuitry and deactivate at least another partial filter circuit of the plurality of partial filter circuits of the filter circuitry.

According to an embodiment, in order to change the gain of the filter circuitry, the at least one processor may be configured to change a weight of each of a plurality of partial filter circuits of the filter circuitry.

According to an embodiment, the audio device may comprise a housing coupled to the at least one sensor, and a protrusion unit coupled with the housing. The at least one microphone may comprise a feedback microphone disposed on a surface of the housing to which the protrusion unit is coupled.

According to an embodiment, the audio device may comprise a housing coupled to the at least one sensor, and a protrusion unit coupled with the housing. The at least one microphone may comprise a reference microphone disposed on a surface of the housing to which the at least one sensor is coupled.

According to an embodiment, the at least one sensor may comprise a touch detection sensor. The external input detected by the touch detection sensor may comprise a touch input.

According to an embodiment, in order to generate the tuning signal, the at least one processor may be configured to obtain first phase information of the noise signal. The at least one processor may be configured to obtain second phase information for cancelling the first phase information. The at least one processor may be configured to generate the tuning signal based on the second phase information.

According to an embodiment, in order to change the gain of the filter circuitry, the at least one processor may be configured to reduce a gain for frequencies within a designated range for howling cancelation based on a pressure of the external input.

As described above, according to an embodiment, an audio device may comprise at least one processor, at least one speaker, at least one microphone, filter circuitry, and at least one sensor. The at least one processor may be configured to receive an external signal through the at least one microphone. The at least one processor may be configured to generate a tuning signal based on the external signal. The at least one processor may be configured to output the generated tuning signal through the at least one speaker. The at least one processor may be configured to detect an external input through the at least one sensor. The at least one processor may be configured to change a gain of the filter circuitry based on the external input. The at least one processor may be configured to generate an output signal by passing an audio signal received through the at least one microphone, through the filter circuitry of which the gain has been changed. The at least one processor may be configured to output the output signal through the at least one speaker.

According to an embodiment, in order to change the gain of the filter circuitry, the at least one processor may be configured to activate at least one partial filter circuit of a plurality of partial filter circuits of the filter circuitry. The at least one processor may be configured to deactivate at least another partial filter circuit of the plurality of partial filter circuits of the filter circuitry.

According to an embodiment, in order to change the gain of the filter circuitry, the at least one processor may be configured to change a weight of each of a plurality of partial filter circuits of the filter circuitry.

According to an embodiment, the audio device may comprise a housing coupled to the at least one sensor, and a protrusion unit coupled with the housing. The at least one microphone may comprise a reference microphone disposed on a surface of the housing to which the at least one sensor is coupled.

According to an embodiment, the at least one sensor may comprise a touch detection sensor. The external input detected by the touch detection sensor may comprise a touch input.

According to an embodiment, in order to generate the tuning signal, the at least one processor may be configured to obtain first phase information of the noise signal. The at least one processor may be configured to obtain second phase information for amplifying the first phase information. The at least one processor may be configured to generate the tuning signal based on the second phase information.

According to an embodiment, in order to change the gain of the filter circuitry, the at least one processor may be configured to reduce a gain for frequencies within a designated range for howling cancelation based on a pressure of the external input.

As described above, according to an embodiment, a method performed by an audio device may comprise outputting a first audio signal through at least one speaker. The method may comprise receiving a noise signal through at least one microphone. The method may comprise generating a tuning signal based on the noise signal. The method may comprise outputting a second audio signal, in which the generated tuning signal and the first audio signal are combined, through the at least one speaker. The method may comprise detecting an external input through at least one sensor. The method may comprise changing a gain of filter circuitry based on the external input. The method may comprise generating an output signal by passing the second audio signal received through the at least one microphone, through the filter circuitry of which the gain has been changed. The method may comprise outputting the output signal through the at least one speaker.

According to an embodiment, the changing the gain of the filter circuitry may comprise activating at least one partial filter circuit of a plurality of partial filter circuits of the filter circuitry. The changing the gain of the filter circuitry may comprise deactivating at least another partial filter circuit of the plurality of partial filter circuits of the filter circuitry.

According to an embodiment, the changing the gain of the filter circuitry may comprise changing a weight of each of a plurality of partial filter circuits of the filter circuitry.

According to an embodiment, the at least one microphone may comprise a feedback microphone disposed on a surface of a housing to which a sensor is coupled.

According to an embodiment, the at least one microphone may comprise a reference microphone disposed on a surface of a housing to which a protrusion unit is coupled.

According to an embodiment, a non-transitory computer-readable medium is provided. The non-transitory computer-readable medium, when executed by one or more processors, may be provisioned with program instructions that perform functions including outputting a first audio signal through at least one speaker, receiving a noise signal through at least one microphone, generating a tuning signal based on the noise signal, outputting a second audio signal, in which the generated tuning signal and the first audio signal are combined, through the at least one speaker, detecting an external input through at least one sensor, changing a gain of the filter circuitry based on the external input, generating an output signal by passing the second audio signal received through the at least one microphone, through the filter circuitry of which the gain has been changed, and outputting the output signal through the at least one speaker.

According to an embodiment, a non-transitory computer-readable medium, when executed by one or more processors, may be provisioned with program instructions that perform functions including receiving an external signal through at least one microphone, generating a tuning signal based on the external signal, outputting a second audio signal, in which the generated tuning signal and the first audio signal are combined, through at least one speaker, detecting an external input through at least one sensor, changing a gain of filter circuitry based on the external input, generating an output signal by passing the second audio signal received through the at least one microphone, through the filter circuitry of which the gain has been changed, and outputting the output signal through the at least one speaker.

The electronic device according to one or more embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

One or more embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. A singular form of a noun corresponding to an item may include one or more of the things unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), it means that the element may be coupled with the other element directly (e.g., via a wire), wirelessly, or via a third element.

As used in connection with one or more embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

One or more embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to an embodiment, a method according to one or more embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to one or more embodiments, each component (e.g., a module or a program) of the above-described components may include a single entity or multiple entities, and some of the multiple entities may be separately disposed in different components. According to one or more embodiments, one or more of the above-described components may be omitted, or one or more other components may be added. Alternatively or additionally, a plurality of components (e.g., modules or programs) may be integrated into a single component.

In such a case, according to one or more embodiments, the integrated component may still perform one or more functions of each of the plurality of components in the same or similar manner as they are performed by a corresponding one of the plurality of components before the integration. According to one or more embodiments, operations performed by the module, the program, or another component may be carried out sequentially, in parallel, repeatedly, or heuristically, or one or more of the operations may be executed in a different order or omitted, or one or more other operations may be added.

What is claimed is:

1. An audio device comprising:
at least one speaker;
at least one microphone;
filter circuitry comprising a plurality of partial filter circuits;
at least one sensor; and
at least one processor comprising processing circuitry, operatively connected to the at least one speaker, the at least one microphone, the filter circuitry, and the at least one sensor;
wherein the at least one processor is configured to:
output a first audio signal through the at least one speaker,
receive a noise signal through the at least one microphone,
generate a tuning signal based on the noise signal,
output, through the at least one speaker, a second audio signal in which the generated tuning signal and the first audio signal are combined,
detect an external input through the at least one sensor,
change a gain of the filter circuitry based on the external input,
generate an output signal by passing, through the filter circuitry with the changed gain, the second audio signal received through the at least one microphone, and
output the output signal through the at least one speaker.

2. The audio device of claim 1, wherein the at least one processor is, to change the gain of the filter circuitry, configured to activate at least one partial filter circuit of the plurality of partial filter circuits and deactivate at least another partial filter circuit of the plurality of partial filter circuits.

3. The audio device of claim 1, wherein the at least one processor is, to change the gain of the filter circuitry, configured to change a weight of each of the plurality of partial filter circuits.

4. The audio device of claim 1, further comprising:
a housing coupled to the at least one sensor; and
a protrusion part coupled with the housing,
wherein the at least one microphone comprises a feedback microphone on a surface of the housing.

5. The audio device of claim 1, further comprising:
a housing coupled to the at least one sensor; and
a protrusion part coupled with the housing,
wherein the at least one microphone comprises a reference microphone on a surface of the housing.

6. The audio device of claim 1, wherein the at least one sensor comprises a touch detection sensor, and
wherein the external input detected by the touch detection sensor comprises a touch input.

7. The audio device of claim 1, wherein the at least one processor is, to generate the tuning signal, configured to:
obtain first phase information of the noise signal; and
obtain second phase information for cancelling the first phase information, and
wherein the tuning signal is generated based on the second phase information.

8. The audio device of claim 1, wherein the at least one processor is, to change the gain of the filter circuitry, configured to reduce a gain for frequencies within a designated range for howling cancelation based on a pressure of the external input.

9. A method performed by an audio device, the method comprising:
outputting a first audio signal through at least one speaker,
receiving a noise signal through at least one microphone,
generating a tuning signal based on the noise signal,
outputting, through the at least one speaker, a second audio signal in which the generated tuning signal and the first audio signal are combined,
detecting an external input through at least one sensor,
changing a gain of filter circuitry based on the external input;
generating an output signal by passing, through the filter circuitry with the changed gain, the second audio signal received through the at least one microphone; and
outputting the output signal through the at least one speaker.

10. The method of claim 9, wherein the changing the gain of the filter circuitry, comprises:
activating at least one partial filter circuit of a plurality of partial filter circuits of the filter circuitry; and
deactivating at least another partial filter circuit of the plurality of partial filter circuits of the filter circuitry.

11. The method of claim 9, wherein the changing the gain of the filter circuitry, comprises changing a weight of each of a plurality of partial filter circuits of the filter circuitry.

12. The method of claim 9, wherein the at least one microphone comprises a feedback microphone on a surface of a housing to which a sensor is coupled.

13. The method of claim 9, wherein the at least one microphone comprises a reference microphone on a surface of a housing to which a protrusion part is coupled.

14. The method of claim 9,
wherein the at least one sensor comprises a touch detection sensor, and
wherein the external input detected by the touch detection sensor comprises a touch input.

15. The method of claim 9, wherein the generating the tuning signal comprises:
obtaining first phase information of the noise signal; and
obtaining second phase information for cancelling the first phase information, and
wherein the tuning signal is generated based on the second phase information.

16. The method of claim 9, wherein the changing the gain of the filter circuitry comprises:
reducing a gain for frequencies within a designated range for howling cancelation based on a pressure of the external input.

17. A non-transitory computer-readable medium, when executed by one or more processors, provisioned with program instructions that perform functions including:
outputting a first audio signal through at least one speaker,
receiving a noise signal through at least one microphone,
generating a tuning signal based on the noise signal,
outputting, through the at least one speaker, a second audio signal in which the generated tuning signal and the first audio signal are combined,
detecting an external input through at least one sensor,
changing a gain of filter circuitry based on the external input;
generating an output signal by passing, through the filter circuitry with the changed gain, the second audio signal received through the at least one microphone; and
outputting the output signal through the at least one speaker.

18. The non-transitory computer-readable medium of claim 17, wherein the changing the gain of the filter circuitry includes:
activating at least one partial filter circuit of a plurality of partial filter circuits of the filter circuitry; and
deactivating at least another partial filter circuit of the plurality of partial filter circuits of the filter circuitry.

19. The non-transitory computer-readable medium of claim 17, wherein the changing the gain of the filter circuitry includes changing a weight of each of a plurality of partial filter circuits of the filter circuitry.

20. The non-transitory computer-readable medium of claim 17, wherein the at least one microphone comprises a feedback microphone on a surface of a housing to which a sensor is coupled.
